(19) United States
(12) Patent Application Publication
(10) Pub. No.: US 2026/0319077 A1
(43) Pub. Date: Oct. 15, 2026

(54) METHOD FOR CALIBRATING AND/OR ADJUSTING THE INTRINSIC COORDINATE SYSTEM OF A VEHICLE ASSEMBLY RELATIVE TO A COORDINATE SYSTEM OF THE VEHICLE AND VEHICLE TEST BENCH FOR IMPLEMENTING THE METHOD

(71) Applicant: DÜRR ASSEMBLY PRODUCTS GMBH, Püttlingen (DE)

(72) Inventors: Thomas ENGEL, Schwalbach (DE); Ismail KURT, Völklingen (DE); Marc NEY, SaarLouis (DE); Christian PETZINGER, Heusweiler (DE); Patrick KIRSCH, Saarbrücken (DE)

(21) Appl. No.: 18/880,516

(22) PCT Filed: Jun. 29, 2023
(86) PCT No.: PCT/DE2023/100488

§ 371 Date: Dec. 31, 2024

(30) Foreign Application Priority Data
Jul. 21, 2022 (DE) 10 2022 118 260.6

(51) Int. Cl. G01S 7/497

(52) U.S. Cl. CPC G01S 7/4972

(57) ABSTRACT

The present invention relates to a method, in which the position and orientation of a test bench assembly (1) is determined in a current position. The test bench assembly (1) interacts with the vehicle assembly in the vehicle test bench. In order to be able to calibrate the vehicle assembly, the position and orientation of the test bench assembly (1) must be known. The position of the test bench assembly (1) in the vehicle test bench can be altered. This can result in a torque occurring when the test bench assembly (1) is offset to the side, which leads to an inclination of the support (2) of the test bench assembly (1). This inclination of the support (2) should be taken into account and, if necessary, compensated for, when determining the position and orientation of the test bench assembly (1). The invention also relates to a vehicle test bench for carrying out such a method.

### RELATED APPLICATIONS

This application is a national phase of International Application No. PCT/DE2023/100488, filed on Jun. 29, 2023, which claims the benefit of German Application No. 10 2022 118 260.6, filed on Jul. 21, 2022. The foregoing International Application, and German Application are incorporated herein by reference in their entireties and for all purposes.

### FIELD OF THE DISCLOSURE

The disclosure relates to a method for calibrating and/or adjusting the intrinsic coordinate system of a vehicle assembly relative to a coordinate system of the vehicle.

In the calibration of the intrinsic coordinate system of a vehicle assembly relative to a coordinate system of the vehicle, a deviation of the intrinsic coordinate system of the vehicle assembly relative to the coordinate system of the vehicle is stored in a control unit and then taken into consideration in the evaluation of signals of the sensors of the vehicle assembly. It is also possible to perform an adjustment of the vehicle assembly so that its intrinsic coordinate system corresponds to the coordinate system of the vehicle or at most deviates minimally therefrom. If a deviation remains, this can in turn be taken into consideration in the evaluation (calibration).

### BACKGROUND

Vehicle assemblies which sense and assess the surroundings around the vehicle are installed in the vehicle. For this purpose, the vehicle assemblies have to be oriented in a defined manner on a coordinate system of the vehicle. The vehicle assemblies can be, for example, cameras, radar sensors, or LIDAR systems. These vehicle assemblies have an intrinsic coordinate system.

This thus involves aligning the intrinsic coordinate system of the vehicle assemblies relative to the coordinate system of the vehicle. An exact alignment of this intrinsic coordinate system of the vehicle assembly relative to the coordinate system of the vehicle solely by way of a defined installation position of the vehicle cannot be achieved with the required accuracy.

The vehicle assemblies are installed on the vehicle (for example, body, windshield, rear view mirror, bumper, . . . ). The vehicle body therefore represents a reference system for the alignment of the intrinsic coordinate system of the vehicle assembly. There is a definition of an installation position of the vehicle assembly in relation to the vehicle body or to the vehicle body in the “surroundings” of the installation position. Tolerances of the vehicle body as a “reference system” for the installation of the vehicle assembly have the result that tolerances in turn exist for the individual vehicle assemblies for the alignment of the intrinsic coordinate system of the vehicle assembly relative to the coordinate system of the vehicle.

Although the coordinate system of the vehicle body would not have a tolerance, there would always be a specific tolerance for the installation itself at a defined installation position on the vehicle body. A tolerance also results therefrom for the alignment of the intrinsic coordinate system of the respective vehicle assembly relative to the coordinate system of the vehicle.

A further problem for the definition of the alignment of the intrinsic coordinate system of the respective vehicle assembly to the coordinate system of the vehicle is that the relative coordinate system of the vehicle is, among other things, not related to the vehicle body. Provided that the vehicle assemblies relate to the dynamic sensing of the surroundings in running driving operation of the vehicle, the relevant coordinate system is the geometrical driving axis of the vehicle.

This geometrical driving axis is defined as the angle bisector of the toe angle of the wheels of the defined reference axle. In a passenger vehicle, this relates here to the rear axle in which the wheels are typically not steered. If the wheels of this reference axle are steered, the geometrical driving axis of the vehicle is accordingly defined in the operating state in which the steering angle of the wheels of the defined axle are equal to ZERO.

These toe angles are parameters of the chassis geometry of the vehicle.

The coordinate system of the vehicle defined via the geometrical driving axis of the vehicle does not have to correspond to a coordinate system of the vehicle resulting from the geometry of the vehicle body.

Therefore, the intrinsic coordinate systems of the vehicle assemblies are calibrated relative to the coordinate system of the vehicle. For the calibration and/or adjustment of these vehicle assemblies, the vehicle is moved into a vehicle test bench, in which the coordinate system of the vehicle is measured relative to the coordinate system of the vehicle test bench. Alternatively, the vehicle can also be positioned in the vehicle test bench so that the coordinate system of the vehicle is defined relative to the coordinate system of the vehicle test bench. Test bench assemblies, the intrinsic coordinate system of which is known relative to the coordinate system of the vehicle test bench, are arranged in the vehicle test bench.

A method is known from DE 10 2019 113 441 A1 for assigning the intrinsic coordinate system of a first assembly of a vehicle for sensing the space laterally to the vehicle relative to a vehicle-related coordinate system. A test bench is designed here for carrying out measurement and/or adjustment work on assemblies of the vehicle and comprises a measuring device for measuring at least one axis of the vehicle-related coordinate system in relation to a coordinate system assigned to the test bench. Furthermore, the intrinsic coordinate system of the measuring device was assigned in a defined manner relative to a coordinate system of the test bench beforehand during a calibration of the test bench. In addition to the measuring device, (at least) one measuring unit is also present. This measuring unit is mechanically fastened to the measuring device such that the intrinsic coordinate system of the measuring unit is assigned in a defined manner with respect to the intrinsic coordinate system of the measuring device.

A method for calibrating a sensing device is known from EP 2 789 997 A1. The sensing device is designed for three-dimensional geometric sensing of the surroundings. The sensing device contains at least one inertial measuring system for the preliminary computational determination of a trajectory of the sensing device. The method includes the following steps:
a) i) positioning and/or orienting the sensing device in a relative position and/or relative orientation to at least one reference point, which is characterized by at least one predetermined relative coordinate, or
   ii) determining at least one relative coordinate, which characterizes the relative position and/or the relative orientation of the sensing device to at least one reference point;
b) determining at least one error variable, which characterizes the deviation of the at least one relative coordinate according to step a) from the preliminary relative coordinate(s) determined by computer of the inertial measuring system;
c) if the error variable meets a predetermined correction criterion: correcting the preliminary trajectory determined by computer of the inertial measuring system.

A method for calibrating at least one vehicle sensor arranged in a vehicle is known from WO 2022 184 475 A1. This method comprises the following steps:
providing the vehicle in a calibration space,
sensing a vehicle position in a space-fixed coordinate system by means of an optical sensing system arranged in the calibration space,
ascertaining a position of the relevant vehicle sensor in the space-fixed coordinate system,
arranging a calibration object in a sensing field of the relevant vehicle sensor in the calibration space,
sensing a calibration object position in the space-fixed coordinate system to obtain a first relative position,
sensing the position of the calibration object by way of the vehicle sensor in the vehicle sensor-fixed coordinate system as a second relative position,
calculating intrinsic and/or extrinsic calibration parameters from a comparison between the first relative position and the second relative position, and
storing the calibration parameters in the relevant vehicle sensor and/or an electronics unit coupled with the relevant vehicle sensor.

### SUMMARY

It can be ascertained from the known relationship between the intrinsic coordinate system of the test bench assembly to the coordinate system of the vehicle test bench and from the known relationship of the coordinate system of the vehicle relative to the coordinate system of the vehicle test bench at which spatial angle of the vehicle assembly the respective test bench assembly has to recognize when the intrinsic coordinate system of the respective vehicle assembly corresponds with the coordinate system of the vehicle. This spatial angle represents a target value. The calibration and/or adjustment of the intrinsic coordinate system of the respective vehicle assembly relative to the coordinate system of the vehicle can be performed from the comparison of the actually measured spatial angle with this target value.

Designing the test bench assemblies in the vehicle test bench so that their position is changeable is known. An adaptation to different vehicles can therefore be performed via the change of the position of the test bench assembly. This is particularly important if the vehicles have different dimensions. The change of the position of a test bench assembly can also take place to simulate different checking and testing situations.

The relationship between the intrinsic coordinate system of a test bench assembly and the coordinate system of the vehicle test bench can be determined during these position changes such that the intrinsic coordinate system of a test bench assembly in a starting position of the test bench assembly in the vehicle test bench (X₀-Y₀-Z₀ position) is measured relative to the coordinate system of the vehicle test bench. A position change of a test bench assembly in the vehicle test bench can take place via the activation of drive units to perform the change of the position of the test bench assembly. A displacement and/or rotation of the test bench assembly results therefrom, wherein it is known from the actuation of the drive units by which distances in the coordinate system of the vehicle test bench the position of the test bench assembly is changed. Accordingly, it is also known via this whether and possibly by which angle the assembly is rotated around one axis or possibly also multiple axes. The relationship of the intrinsic coordinate system of the test bench assembly relative to the coordinate system of the vehicle test bench can be ascertained from the actuation of the drive units to change the position of the assembly if the relationship of the intrinsic coordinate system of the test bench assembly relative to the coordinate system of the vehicle test bench is known in the X₀-Y₀-Z₀ position.

The relationship between the intrinsic coordinate system of a test bench assembly and the coordinate system of the vehicle test bench can also be determined by measuring the position of one or more reference points of the test bench assembly relative to the coordinate system of the vehicle test bench. The intrinsic coordinate system of a test bench assembly in a starting position of the test bench assembly in the vehicle test bench (X₀-Y₀-Z₀ position) is measured relative to the coordinate system of the vehicle test bench.

Exampled disclosed herein are based on the object of improving the accuracy in the ascertainment of the intrinsic coordinate system of a vehicle assembly, even in the event of position changes of the test bench assembly.

This object is achieved by a method for calibrating and/or adjusting the intrinsic coordinate system of a vehicle assembly relative to a coordinate system of the vehicle as claimed in claim 1.

The calibration and/or adjustment is performed in that initially the vehicle is positioned in a vehicle test bench. The coordinate system of the vehicle positioned in the vehicle test bench is defined relative to the coordinate system of the vehicle test bench. This can take place in that the vehicle is positioned in the vehicle test bench and the coordinate system of the vehicle is measured relative to the coordinate system of the vehicle test bench subsequently thereto. This can also take place in that the vehicle is parked in the vehicle test bench at a defined position and having a defined orientation.

Based on an interaction of the vehicle assembly to be calibrated with a test bench assembly, a calibration and/or adjustment of the vehicle assembly is performed. The test bench assembly is positionable in different positions in the vehicle test bench. The intrinsic coordinate system of the test bench assembly is defined here relative to the coordinate system of the vehicle test bench.

The intrinsic coordinate system of the test bench assembly is defined relative to the coordinate system of the vehicle test bench in that the test bench assembly is fastened on a carrier. The position of at least one reference point of the carrier in the coordinate system of the vehicle test bench is ascertained in a starting position (X₀-Y₀-Z₀ position) of the carrier. In addition, the position and/or orientation of the intrinsic coordinate system of the carrier of the test bench assembly is determined in the coordinate system of the vehicle test bench in the starting position (X₀-Y₀-Z₀ position) of the carrier.

During the ascertainment of the position and/or orientation of the intrinsic coordinate system of the test bench assembly in a current position in the coordinate system of the vehicle test bench, the current position of the at least one reference point of the carrier is determined in the coordinate system of the vehicle test bench. The position and/or orientation of the intrinsic coordinate system of the carrier in the coordinate system of the vehicle test bench in the current position is determined as a displacement of the intrinsic coordinate system of the carrier in the current position in relation to the starting position by a determination of the displacement of the at least one reference point of the carrier (in the coordinates of the coordinate system of the vehicle test bench in the current position (X-Y-Z position) in relation to the position of the at least one reference point of the carrier in the coordinate system of the vehicle test bench in the starting position (X₀-Y₀-Z₀ position) of the carrier).

The intrinsic coordinate system of the test bench assembly is defined relative to the coordinate system of the vehicle test bench
in consideration of the position and/or orientation of the intrinsic coordinate system of the test bench assembly relative to the intrinsic coordinate system of the carrier in the current position of the test bench assembly,
in consideration of the change of the position and/or orientation of the intrinsic coordinate system of the carrier in the current position of the test bench assembly in relation to the position and/or orientation of the intrinsic coordinate system of the carrier in the starting position and
in consideration of the position and/or orientation of the intrinsic coordinate system of the carrier in the starting position relative to the coordinate system of the vehicle test bench.

The position and/or orientation of the intrinsic coordinate system of the test bench assembly relative to the intrinsic coordinate system of the carrier is constant if the test bench assembly is rigidly fastened on the carrier and the carrier is rigid as such. The carrier is rigid as such if it does not have any telescoping elements and/or pivot joints, via which the structure of the carrier is changeable via actuatable drive elements. If the carrier is changeable in its structure in the described manner, the change of the structure of the carrier can be taken into consideration via the actuation of the drive elements in the current position in relation to the actuation of the drive elements in the starting position.

The test bench assembly is thus fastened on a carrier which is displaceable in the vehicle test bench such that its current position is known in relation to a starting position. The intrinsic coordinate system of the carrier can be displaced-without a change of the orientation of the intrinsic coordinate system of the carrier in relation to the orientation of the coordinate system of the vehicle test bench.

The carrier can possibly also have telescoping elements and/or pivot joints. A change of the structure of the carrier can take place via these, so that the position and/or orientation of the test bench assembly in the coordinate system of the vehicle test bench can be changed via a change of the structure of the carrier by means of the actuation of drive elements of the telescoping elements or the pivot joints.

The change of the position and/or orientation in the coordinate system of the vehicle test bench can thus take place:
by a displacement of the carrier of the test bench assembly in the vehicle test bench and/or
by a change of the structure of the carrier.

In the procedure according to the prior art, the change of the position and/or orientation of the intrinsic coordinate system of the carrier-except for a displacement of the carrier-is only taken into consideration providing that the structure of the carrier is changed via pivot joints in the carrier or via telescoping elements of the carrier. Changes in the structure of the carrier are executed here via drive elements which are actuated accordingly.

According to examples disclosed herein, it is taken into consideration in the method provided here that the carrier experiences an inclination when the common center of gravity of the carrier having the test bench assembly fastened thereon is no longer located vertically above the contact area of the carrier, but rather is laterally offset. A torque thus occurs, which acts on the contact area of the carrier. If the carrier is stable as such so that it does not deform (sag), a deformation of the carrier can occur in the region of the contact area of the carrier. A pivot axis can also be provided in this region, around which the carrier can rotate in a defined manner in the event of a lateral inclination.

It is essential for the consideration of this inclination of the carrier according to examples disclosed herein that this inclination is not based on the carrier being changed in its structure by a drive. Rather, this inclination is based on the described torque. This inclination results in a change of the intrinsic axis of the carrier in the coordinate system of the vehicle test bench.

The structure of the carrier is defined. This means that in a first embodiment the carrier has a rigid form (i.e.: there is no deformation of the carrier as such). In a further (second) embodiment, the carrier can have one or more joints and/or can be telescopic along one or more elements. The changes of the structure of the carrier thus caused are known due to the actuation of drive elements. Moreover, there is also no further deformation of the carrier in this further embodiment here.

According to examples disclosed herein, the method furthermore comprises the following features. The at least one reference point of the carrier is defined by a straight line on which the reference points are located. This straight line forms a pivot axis around which the carrier rotates as a result of a torque if the center of gravity of the test bench assembly is offset in the vertical direction laterally in relation to this straight line.

The orientation of the carrier in the X₀-Y₀-Z₀ position is measured with respect to an inclination around the pivot axis by means of an inclination measuring unit in the intrinsic coordinate system of the inclination measuring unit. The orientation of the carrier is also measured in the current position by means of the inclination measuring unit with respect to an inclination around the pivot axis in the intrinsic coordinate system of the inclination measuring unit. A change of the orientation of the carrier with respect to the inclination around the pivot axis in the current position in relation to the orientation of the carrier with respect to the inclination around the pivot axis in the X₀-Y₀-Z₀ position is ascertained from the measurement data of the inclination measuring unit.

The orientation of the intrinsic coordinate system of the carrier of the test bench assembly in the coordinate system of the vehicle test bench is ascertained from:

the orientation of the carrier in the coordinate system of the vehicle test bench in the X₀-Y₀-Z₀ position and
by a consideration of the ascertained change of the orientation of the intrinsic coordinate system of the carrier from the measurement data of the inclination measuring unit.

Examples disclosed herein are based on the measurement of the orientation by means of the inclination measuring unit in the context of the evaluation “only” being executed as a differential measurement and change of the orientation in two positions relative to one another. The measured data of the inclination measuring unit are coupled to the coordinate system of the test bench in that the position and orientation of the pivot axis is known (in the coordinate system of the vehicle test bench-both in the starting position and in the current position).

In the simplest case, this pivot axis is constant and does not change. This can be the case, for example, if the carrier of the test bench assembly is guided on a rail and the position and orientation of the rail is known in the coordinate system of the vehicle test bench. If the carrier is displaceable along the rail, but is otherwise rigidly fastened to the rail, however, this rail forms the pivot axis.

In the event of a corresponding torque, deformations of the rail can occur. This can be limited or even avoided entirely if the carrier is mounted on a plate which is mounted via a pivot axis on the rail. The rail is thus “relieved” because the torque is absorbed by this pivot axis. Such a design proves to be advantageous in particular if not only one test bench assembly is guided on this rail, but rather multiple test bench assemblies. With the design of the attachment of the carrier via a pivot axis, feedback effects on the coordinates of other test bench assemblies can be limited or avoided, which result from deformations of the rail.

In the design of the method as claimed in claim 2, the position and/or orientation of a test bench assembly and/or the carrier of the test bench assembly in the X₀-Y₀-Z₀ position is measured in the coordinate system of the vehicle test bench in the X₀-Y₀-Z₀ position of the carrier. This measurement is taken into consideration in the determination of the orientation of the intrinsic coordinate system of the carrier of the test bench assembly in the coordinate system of the vehicle test bench in the current position.

Alternatively to this measurement (and therefore generally in the meaning of claim 1), the position and orientation of the carrier in the X₀-Y₀-Z₀ position can also be produced “by definition” if the carrier is fastened on a structure (such as a guide rail), so that the orientation of the carrier is assumed to be known.

The determination can then take place as follows:

In a first position, the at least one reference point of the carrier is determined in the longitudinal direction of the guide rail. If the carrier has one or more joints, the structure of the carrier is changed so that the center of gravity of the unit “carrier with test bench assembly” is located if possible in the vertical direction above the at least one reference point of the carrier. If the center of gravity cannot be moved directly into a position above the reference point, the center of gravity is positioned so that the acting torque around a pivot axis through the reference point (or the reference points) is as small as possible. This has the result that in this X₀-Y₀-Z₀ position, at most a minor inclination exists due to the lateral displacement of the center of gravity. This is then the X₀-Y₀-Z₀ position, in which the “reference value” of the inclination measuring unit is recorded, to which thereafter all measured values of the inclination measuring unit are related for subtraction. If the movement path of the carrier along the guide rail is known, the current position and orientation of the test bench assembly can therefore be determined in each case.

In the design of the method as claimed in claim 3, the position of the at least one reference point of the carrier in the coordinate system of the vehicle test bench is measured in the current position of the carrier.

This enables, with incorporation of the measured values of the inclination measuring unit, a precise determination of the intrinsic coordinate system of the test bench assembly in relation to the coordinate system of the vehicle test bench.

In the design of the method as claimed in claim 4, the carrier has actuatable drive elements for one or more telescopic elements of the carrier and/or actuatable drive elements for rotating parts of the carrier around one or more pivot joints of the carrier. To compensate for the described effects of a torque, these actuatable drive elements are actuated such that a correction of the position and/or orientation of the intrinsic coordinate system of the test bench assembly relative to the coordinate system of the vehicle test bench is carried out by the following measures. Initially, a target position and target orientation of the intrinsic coordinate system of the test bench assembly are determined in the coordinate system of the vehicle test bench from:
the determination of the position of the at least one reference point of the carrier in the current position in the coordinate system of the vehicle test bench,
the determination of the position and orientation of the intrinsic coordinate system of the test bench assembly in the intrinsic coordinate system of the carrier, and
the consideration of the orientation of the intrinsic coordinate system of the carrier relative to the coordinate system of the vehicle test bench in the X₀-Y₀-Z₀ position.

The target position of the intrinsic coordinate system of the test bench assembly is thus initially ascertained so that the effects of the deviation discussed, which are caused by the described torque, are neglected.

The positioning elements of the carrier are then adjusted such that the actual position and the actual orientation of the intrinsic coordinate system of the test bench assembly in the coordinate system of the vehicle test bench in the current position correspond to the target position and target orientation of the test bench assembly in the coordinate system of the vehicle test bench.

The actuatable drive elements are thus actuated here so that an inclination of the carrier (which would result in a deviation of the intrinsic coordinate system of the test bench assembly) is balanced out by the actuation of the drive elements so that this inclination of the carrier is compensated for by a targeted change of the structure of the carrier. This change of the structure takes place such that the actual position and actual orientation of the intrinsic coordinate system of the test bench assembly correspond to the target position and target orientation of the intrinsic coordinate system of the test bench assembly.

Claim 5 relates to a vehicle test bench for performing a method as claimed in any one of the preceding claims. The vehicle test bench has a test bench assembly having a linearly-guided position change. The carrier of the test bench assembly is mounted by means of a bearing element on or at a rail. The mounting of the bearing element is carried out such that the bearing element of the carrier of the test bench assembly is movable in the longitudinal direction of the rail via drive means or manually into various positions. According to examples disclosed herein, the bearing element has a support element, via which the bearing element is additionally mounted adjacent to the rail.

This design proves to be advantageous because the weight of the carrier having the test bench assembly fastened thereon does not have to be completely absorbed by the rail. A part of the weight- and also of the described torque-is absorbed (dissipated) by the support element. The described effect of the inclination of the carrier as a result of the torque is thus reduced.

The bearing element can be mounted on a bottom rail in the vehicle test bench. Depending on the design of the vehicle test bench, the bearing element can be mounted on a rail which is part of a gantry system in the vehicle test bench. Such a gantry system has the advantage that the bottom region of the vehicle test bench remains free, so that other measuring units can be positioned there or a correspondingly enlarged entry and exit region of the vehicle is available.

It proves to be advantageous to carry out a method according to examples disclosed herein for the remaining inclination of the carrier.

It is to be noted that the attachment of the support element to reduce or avoid the inclination of the carrier alone represents a disclosed example in relation to the prior art as such. The right is expressly reserved of filing a divisional application based on this design embodiment, in which expressly none of the above-mentioned methods is executed.

In the design of a vehicle test bench as claimed in claim 6, the bearing element consists of two parts connected to one another via a pivot axis. The first part of the bearing element is mounted on the rail. The second part of the bearing element is mounted via the support element adjacent to the rail.

This proves to be advantageous insofar as feedback effects of the described torque on the rail can be reduced thereby. A possible deformation of the rail can thus be reduced or avoided entirely.

The design of the vehicle test bench as claimed in claim 6 can also be part of the claimed divisional application.

Insofar as one of the above-mentioned methods is executed in the design of a vehicle test bench as claimed in claim 6, the position and orientation of the pivot axis is advantageously defined via the connection of the two parts of the bearing element.

In the design of the vehicle test bench as claimed in claim 7, the bearing element consists of two parts connected to one another. The first part of the bearing element is mounted on the rail. The second part of the bearing element is displaceable in relation to the first part of the bearing element in the Z direction and is mounted via the support element adjacent to the rail.

Alternatively or additionally to the connection of the two parts via the pivot axis in the meaning of claim 6, the two parts can also be connected to one another so that the second part is displaceable in the Z direction in relation to the first part. The second part is in turn supported via a support element.

If the rail is a bottom rail, it depends on the planarity of the bottom of the vehicle test bench whether an inclination of the carrier is possibly caused by raising or lowering of the support element. This inclination can occur if a pivot axis in the meaning of claim 6 is present or also with a rigid bearing element, if a deformation of the rail occurs.

In this context, it is advantageous if the two parts are displaceable in relation to one another in the vertical direction (Z direction). The second part can then be raised or lowered in accordance with a protrusion in the ground or a wave in the ground. A feedback effect on the rail is reduced or avoided entirely by the displaceability of the second part of the bearing element in relation to the first part of the bearing element in the Z direction. In addition, due to the displacement in the Z direction, no inclination of the carrier occurs as a result of ground irregularities depending on the position of the support element.

### BRIEF DESCRIPTION OF THE DRAWINGS

An exemplary embodiment of examples disclosed herein are shown in the drawings. In the figures:

FIG. 1: shows a test bench assembly fastened on a carrier which has telescopic elements and pivot joints

FIG. 2: shows the test bench assembly according to FIG. 1 in a further operating position,

FIG. 3: shows the test bench assembly according to FIG. 1 in a further operating position,

FIG. 4: shows a top view of a bearing element, on which a carrier is attached, with a rail, on which the bearing element is guided,

FIG. 5: shows a vertical section through the illustration of FIG. 4 with a first bearing element, and

FIG. 6: shows a vertical section through the illustration of FIG. 4 with a further bearing element.

### DETAILED DESCRIPTION OF THE DRAWINGS

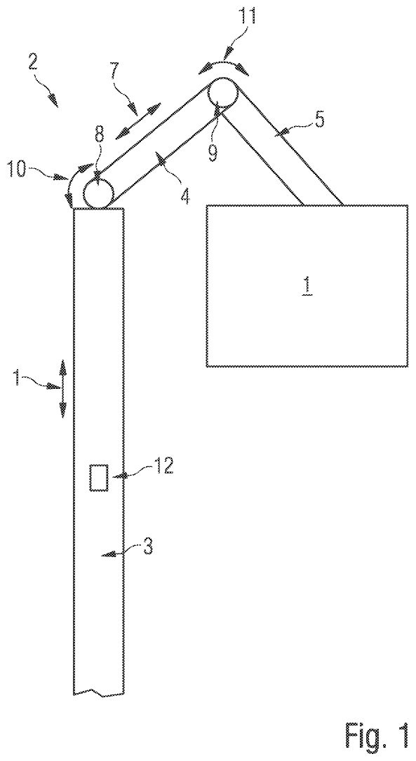

FIG. 1 shows a test bench assembly 1, which is fastened on a carrier 2. The carrier consists of multiple elements 3, 4, and 5.

The elements 3 and 4 can be telescoped in accordance with the arrows 6 and 7.

The elements 3 and 4 and the elements 4 and 5 are connected to one another via pivot joints 8 and 9. These elements can be rotated relative to one another in accordance with the arrows 10 and 11.

Actuatable drive elements are provided for the rotation around the pivot joints 8 and 9.

Actuatable drive elements are also provided to implement the ability to telescope of elements 3 and 4.

The test bench assembly 1 is fastened on the element 5. This fastening also takes place via a pivot joint (not shown here).

The carrier 2 and therefore also the test bench assembly 1 fastened thereon are movable in a vehicle test bench. For example, the carrier 2 can be guided along a rail, a chain, or a guide cable.

It can be seen that an inclination measuring unit 12 is fastened on the element 3 of the carrier 2. This inclination measuring unit 12 can be, for example, a MEMS sensor known per se.

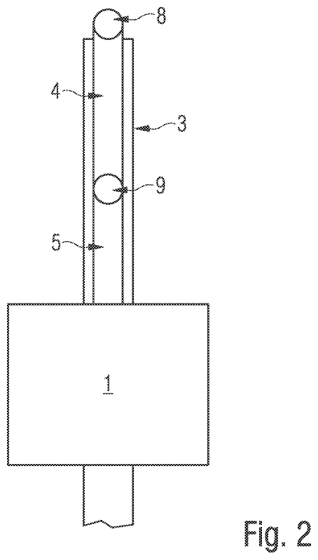

FIG. 2 shows the test bench assembly 1 according to FIG. 1 in a further operating position. In the operating position shown here, the center of gravity of the carrier 2 and of the test bench assembly 1 is located above the contact area of the carrier 2. This is advantageously the X₀-Y₀-Z₀ position, which is designated as the starting position in the context existing here.

In the starting position, no torque acts due to the carrier 2 and the test bench assembly 1, which could result in an inclination of the carrier.

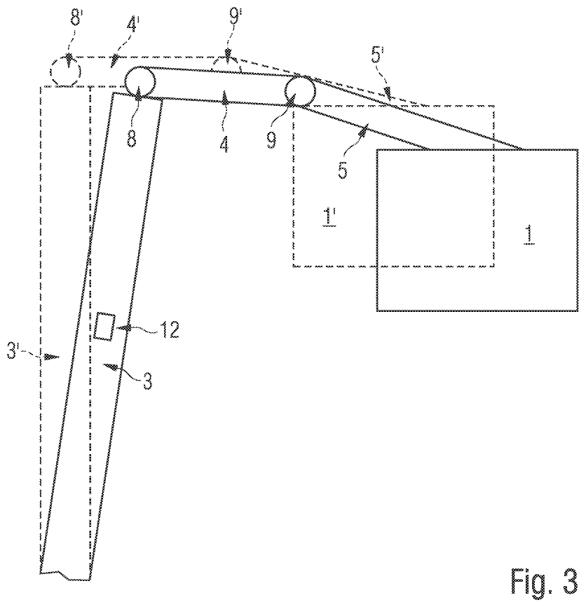

FIG. 3 shows the test bench assembly 1 according to FIG. 1 in a further operating position.

It can be seen that the test bench assembly is positioned by a corresponding rotation in the pivot joints 8 and 9 in a lateral offset in relation to the contact area of the carrier 2 (defined by the contact area of the element 3). A torque thus arises, which results in a lateral inclination of the carrier 2.

In FIG. 3, the arrangement in which the carrier 2 with the test bench assembly 1 would be located if the carrier 2 were not inclined is shown by dashed lines.

The dashed line representation therefore corresponds to the “target position and target orientation” of the intrinsic coordinate system of the test bench assembly, which is then provided with the reference sign 1′. Accordingly, the parts of the carrier 2′ are also provided with the reference signs 3′, 8′, 4′, 9′, 5′.

The deviation shown can be taken into consideration by a conversion in the evaluation (i.e. in the calibration and/or adjustment of the vehicle assembly).

In the exemplary embodiment shown here, the structure of the carrier 2 is adjustable by the telescoping elements 3 and 4 and the pivot joints 8 and 9. It is therefore also possible to balance out the deviation of the actual position and actual orientation of the test bench assembly (position 1) from the target position and target orientation (position 1′) recognized according to examples disclosed herein. This balancing takes place so that the test bench assembly 1 (in consideration of the inclination of the carrier 2 as a result of the torque, which is caused by the lateral offset of the test bench assembly) is located back at the target position (1′)—also having the target orientation.

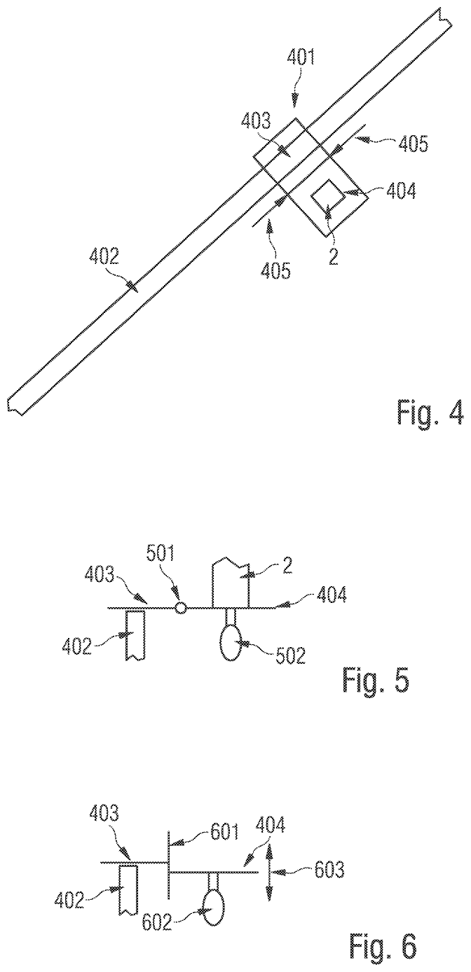

FIG. 4 shows a top view of a bearing element 401, on which a carrier 2 is attached.

The bearing element 401 is guided on a rail 402.

The bearing element 401 consists of a first part 403 and a second part 404. The first part 403 is fastened on a rail 402 and is guided along the rail 402. The second part 404 is fastened on the first part 403, shown by the marking arrows 405.

This fastening can be such that the two parts 403 and 404 are movable in relation to one another along a pivot axis and/or are displaceable in relation to one another in the vertical direction at the point identified by the marking arrows 405.

A carrier 2 is attached to the second part 404 of the bearing element 401.

FIG. 5 shows a vertical section through the illustration of FIG. 4 with a first bearing element.

The rail 402, the first part 403 of the bearing element, the second part 404 of the bearing element, and the carrier 2 (partially) are shown.

The second part 404 of the bearing element is supported via a wheel 502 on the ground.

A pivot axis 501 can be seen, around which the second part 404 of the bearing element is pivotable in relation to the first part 403.

If the wheel 502 of the second part 404 of the bearing element is moved along the rail 402 over ground irregularities during a movement of the bearing element, these ground irregularities can be balanced out by a pivot movement of the second part 404 of the bearing element in relation to the first part 403 of the bearing element.

In addition, due to this type of the fastening of the second part 404 of the bearing element on the first part 403 of the bearing element by this pivot axis, a defined pivot axis also results for an inclination of the carrier 2 as a result of a torque, which can occur due to a lateral displacement of the common center of gravity of the carrier with the test bench assembly 1 fastened thereon.

The inclination of the carrier 2 thus changes, which can be measured using the inclination meter and balanced out, however-by computer or by an actuation of the drive elements to change the structure of the carrier 2.

Feedback effects of the bearing element on the rail 402 can be restricted by this arrangement.

FIG. 6 shows a vertical section through the illustration of FIG. 4 with a further bearing element.

The rail 402, the first part 403 of the bearing element, and the second part 404 of the bearing element are shown. The carrier 2 is not shown here, but is also located on the second part 404 of the bearing element in this embodiment.

The second part 404 of the bearing element is supported via a wheel 602 on the ground.

It can be seen that the second part 404 of the bearing element is fastened on the first part 403 of the bearing element, wherein the second part 404 of the bearing element is displaceable in the vertical direction in relation to the first part of the bearing element in accordance with the arrow 603.

If the wheel 602 of the second part 404 of the bearing element is moved along the rail 402 over ground irregularities during a movement of the bearing element, these ground irregularities can be balanced out by a movement in the vertical direction of the second part 404 of the bearing element in relation to the first part 403 of the bearing element. The inclination of the carrier 2 thus does not change, but the Z coordinate of the carrier (and therefore also of the test bench assembly 1) is changed.

Feedback effects of the bearing element on the rail 402 can also be restricted by this arrangement.

1. A method comprising calibrating and/or adjusting an intrinsic coordinate system of a vehicle assembly relative to a coordinate system of a vehicle,
wherein the calibration and/or adjustment is performed in that the vehicle is positioned in a vehicle test bench,
wherein a calibration and/or adjustment of the vehicle assembly is performed based on an interaction of the vehicle assembly to be calibrated with a test bench assembly,
wherein the test bench assembly is positionable in the vehicle test bench in different positions,
wherein the intrinsic coordinate system of the test bench assembly is defined relative to the coordinate system of the vehicle test bench,
wherein the coordinate system of the vehicle positioned in the vehicle test bench is defined relative to the coordinate system of the vehicle test bench,
wherein the intrinsic coordinate system of the test bench assembly is defined relative to the coordinate system of the vehicle test bench in that the test bench assembly is fastened on a carrier,
wherein the position of at least one reference point of the carrier in the coordinate system of the vehicle test bench is ascertained in a starting position of the carrier,
wherein a position and/or orientation of the intrinsic coordinate system of the carrier of the test bench assembly is determined in the coordinate system of the vehicle test bench in the starting position position) of the carrier,
wherein the position and/or orientation of the intrinsic coordinate system of the test bench assembly is ascertained in a current position in the coordinate system of the vehicle test bench,
wherein for this purpose the current position of the at least one reference point of the carrier is determined in the coordinate system of the vehicle test bench,
wherein the position and/or orientation of the intrinsic coordinate system of the carrier in the coordinate system of the vehicle test bench in the current position is determined as a displacement of the intrinsic coordinate system of the carrier in the current position in relation to the starting position by a determination of the displacement of the at least one reference point of the carrier
in the coordinates of the coordinate system of the vehicle test bench in the current position
in relation to
the position of the at least one reference point of the carrier in the coordinate system of the vehicle test bench in the starting position position) of the carrier,
wherein the intrinsic coordinate system of the test bench assembly is defined relative to the coordinate system of the vehicle test bench
in consideration of the position and/or orientation of the intrinsic coordinate system of the test bench assembly relative to the intrinsic coordinate system of the carrier in the current position of the test bench assembly,
in consideration of the change of the position and/or orientation of the intrinsic coordinate system of the carrier in the current position of the test bench assembly in relation to the position and/or orientation of the intrinsic coordinate system of the carrier in the starting position, and
in consideration of the position and/or orientation of the intrinsic coordinate system of the carrier in the starting position relative to the coordinate system of the vehicle test bench, wherein:
the at least one reference point of the carrier is defined by a straight line on which the reference points are located,
wherein the straight line forms a pivot axis, around which the carrier rotates as a result of a torque if a common center of gravity of the carrier and the test bench assembly is offset in a vertical direction laterally in relation to the straight line,
the orientation of the carrier in the starting position with respect to an inclination around the pivot axis is measured by means of an inclination measuring unit in the intrinsic coordinate system of the inclination measuring unit,
the orientation of the carrier in the current position with respect to an inclination around the pivot axis is measured by means of the inclination measuring unit in the intrinsic coordinate system of the inclination measuring unit,
a change of the orientation of the carrier with respect to an inclination around the pivot axis in the current position in relation to the orientation of the carrier with respect to an inclination around the pivot axis in the starting position is ascertained from measurement data of the inclination measuring unit, and
a determination of the orientation of the intrinsic coordinate system of the carrier of the test bench assembly in the coordinate system of the vehicle test bench is ascertained from:
the orientation of the carrier in the coordinate system of the vehicle test bench in the starting position and
by a consideration of the ascertained change of the orientation of the intrinsic coordinate system of the carrier from the measurement data of the inclination measuring unit.

2. The method as claimed in claim 1 wherein
a measurement of the position and/or orientation of a test bench assembly (1) and/or the carrier of the test bench assembly in the starting position in the coordinate system of the vehicle test bench takes place in the starting position of the carrier and
the measurement is taken into consideration in the determination of the orientation of the intrinsic coordinate system of the carrier of the test bench assembly in the coordinate system of the vehicle test bench in the current position.

3. The method as claimed in claim 2, characterized in that
the position of the at least one reference point of the carrier in the coordinate system of the vehicle test bench is measured in the current position of the carrier.

4. The method as claimed in claim 1, characterized in that
in the case of a carrier (2) having actuatable drive elements for one or more telescoping elements and/or having actuatable drive elements for rotating parts of the carrier around one or more pivot joints, a correction of the position and/or orientation of the intrinsic coordinate system of the test bench assembly relative to the coordinate system of the vehicle test bench is carried out by the following measures:
determining a target position and target orientation of the intrinsic coordinate system of the test bench assembly in the coordinate system of the vehicle test bench from:
determining the position of the at least one reference point of the carrier in the current position in the coordinate system of the vehicle test bench,
determining the position and orientation of the intrinsic coordinate system of the test bench assembly in the intrinsic coordinate system of the carrier,
taking into consideration the orientation of the intrinsic coordinate system of the carrier relative to the coordinate system of the vehicle test bench in the starting position,
adjusting positioning elements of the carrier such that the actual position and actual orientation of the intrinsic coordinate system of the test bench assembly in the coordinate system of the vehicle test bench in the current position correspond to the target position and target orientation of the test bench assembly in the coordinate system of the vehicle test bench.

5. A vehicle test bench for performing a method as claimed in claim 1,
wherein the vehicle test bench has a test bench assembly having a linearly-guided position change,
wherein the carrier is mounted by means of a bearing element on or at a rail,
wherein the mounting of the bearing element takes place such that the bearing element of the carrier of the test bench assembly is movable into various positions in a longitudinal direction of the rail via drive means or manually, and wherein
the bearing element has a support element, via which the bearing element is additionally mounted adjacent to the rail.

6. The vehicle test bench as claimed in claim 5, wherein
the bearing element consists of includes two parts connected to
one another via a pivot axis,
wherein the first part of the bearing element is mounted on the rail and
wherein the second part of the bearing element is mounted via the support element adjacent to the rail.

7. The vehicle test bench as claimed in claim 5, wherein
the bearing element (401) consists of includes two parts connected to one another,
wherein the first part (403) of the bearing element is mounted on the rail and
wherein the second part of the bearing element
is displaceable in relation to the first part of the bearing element in a Z direction
is mounted via the support element adjacent to the rail.
